(19) United States
(12) Patent Application Publication
(10) Pub. No.: US 2009/0086495 A1
(43) Pub. Date: Apr. 2, 2009

(54) Surgical Lighting System and Surgical Light with Image-Recording Function

(76) Inventor: Tien-Sheng Chen, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/934,133

(22) Filed: Nov. 2, 2007

(30) Foreign Application Priority Data
Oct. 2, 2007 (TW) 096216464

(51) Int. Cl. F21S 8/06; H04N 7/18

(52) U.S. Cl. 362/427; 348/143

(57) ABSTRACT

The present invention provides a surgical lighting system with an image-recording function mainly comprising a surgical light set and a flexible tube-shaped video camera connected to the surgical light set. The surgical light set comprises a fixed base; a rotary arm set pivoted to the fixed base, the rotary arm set comprising at least one rotary arm; and a surgical light connected to one rotary arm of the rotary arm set.

### BACKGROUND OF THE INVENTION

1. Field of the Invention

The present invention relates to a surgical lighting system with an image-recording function; more particularly, the present invention relates to a surgical lighting system with a flexible tube-shaped video camera.

2. Description of the Related Art

Recording the whole process of surgery by means of video provides several advantages; for example, the video clips may be used in educational situations or serve as evidence in a malpractice lawsuit. In addition, these clips can be used for discussions of surgical skills among peers and for distance medicine via real-time data transmission.

Currently, at least three kinds of image-recording means are commonly in use. The first one, and also the simplest one, involves an assistant holding a handheld image-recording apparatus who records the surgery during the surgical operation. The main problems inherent in this approach are that an extra person is needed to do the job, that the extra person sometimes interferes in the surgical procedure, and that the quality of the video may be impaired when the image-recording apparatus is shaken.

The second one is that one of the surgeons (usually the one performing the surgical procedure) wears an image-recording apparatus. Commonly used image-recording apparatuses are head-wearable, such as the MICROLUX™ DLX headlight camera system. This type of image-recording has an advantage over the first type because it provides a wearable apparatus for recording the surgical procedure from the wearer's viewpoint, and no extra person is needed. However, since the wearer's viewpoint changes frequently, the final recorded video inevitably lacks stable images. Furthermore, wearing the apparatus for a long time inevitably causes the wearer to experience physical fatigue.

The third one is the use of a fixed image-recording system. Generally, an image-recording system is fixed somewhere appropriate for recording the surgical procedure, such as in the space next to the operation table. In addition, an image-recording system may be directly installed on the surgical light set, such as the SURGICAM™ or the one disclosed in U.S. Pat. No. 6,909,465. Due to the limited movable angle of the surgical light set, however, these inventions can provide only a limited range of angles and images.

### SUMMARY OF THE INVENTION

It is an object of the present invention to provide a novel surgical lighting system with an image-recording function mainly comprising a surgical light set and a flexible tube-shaped video camera connected to the surgical light set. The surgical light set comprises a fixed base; a rotary arm set pivoted to the fixed base, the rotary arm set comprising at least one rotary arm; and a surgical light connected to one rotary arm of the rotary arm set.

In this invention, the flexible tube-shaped video camera may be connected to any part of the surgical light set, such as the fixed base, the rotary arm set, or the surgical light; in addition, the connection may or may not be detachable.

Furthermore, the flexible tube-shaped video camera preferably has a zoom function and focus controls; more preferably, the flexible tube-shaped video camera may be controlled by a remote control. Also, to enable a user to confirm the shooting angle of the flexible tube-shaped video camera, the flexible tube-shaped video camera may selectively comprise an indicator which is capable of projecting a visible light beam to an opaque surface and forming a light spot thereon.

It is another object of the present invention to provide a surgical light with an image-recording function which may enable a user to make a video recording of a surgical procedure, the surgical light with an image-recording function mainly comprising: a surgical light and a flexible tube-shaped video camera connected to the surgical light. The surgical light comprises a light cover defining a lighting space; a light source installed in the lighting space; and a handle allowing a user to control the orientation of the light cover.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is an illustration of one embodiment of the surgical lighting system with an image-recording function of this invention.

FIG. 2 is an illustration of the connection between the fixing member and the flexible tube-shaped video camera of the present invention.

FIG. 3 is an illustration of another embodiment of the surgical lighting system with an image-recording function of this invention.

FIG. 4 is an illustration of one embodiment of the surgical light with an image-recording function of this invention.

FIGS. 5 and 6 are illustrations of another embodiment of the surgical light with an image-recording function of this invention.

FIG. 7 is an illustration of one embodiment of the flexible tube-shaped video camera of this invention.

### DETAILED DESCRIPTION OF THE PREFERRED EMBODIMENT

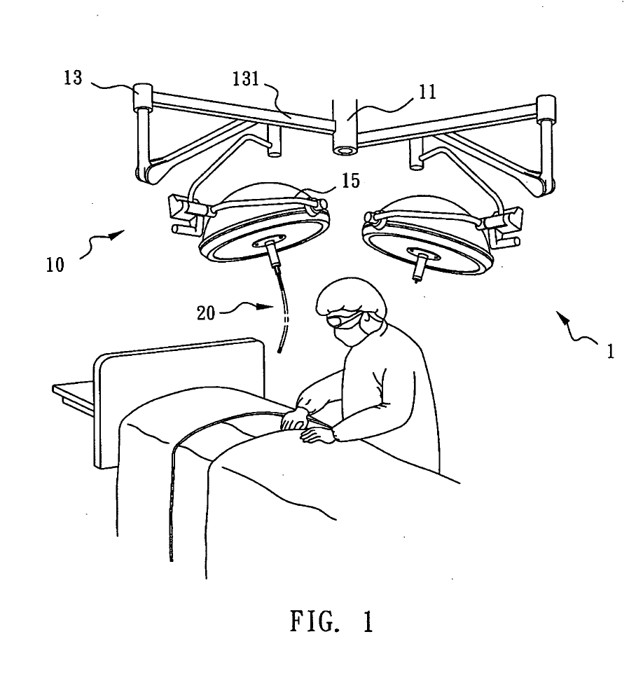

Please refer to FIG. 1 for an illustration of one embodiment of the surgical lighting system 1 with an image-recording function of this invention. As shown, the surgical lighting system 1 with an image-recording function mainly comprises a surgical light set 10 which comprises: (a) a fixed base 11; (b) a rotary arm set 13 pivoted to the fixed base 11, the rotary arm set 13 comprising at least one rotary arm 131; and (c) a surgical light 15 connected to one rotary arm 131 of the rotary arm set 13; and a flexible tube-shaped video camera 20 connected to the surgical light set 10.

With the use of the flexible tube-shaped video camera 20, the surgical lighting system 1 with an image-recording function of this invention can provide not only a lighting effect but also an image-recording effect without limitation. In FIG. 1, the flexible tube-shaped video camera 20 is connected the surgical light 15. However, it should be emphasized that the flexible tube-shaped video camera 20 may also be connected to the fixed base 11 or the rotary arm set 13. The connection may be detachable or not detachable.

Since the flexible tube-shaped video camera 20 is flexible and has a longer body than the commonly used video camera, a better shooting effect may be obtained. Users may easily direct the flexible tube-shaped video camera 20 to a desirable position to record the surgical operation without being restricted by the limited movement capacity of the surgical light set 10.

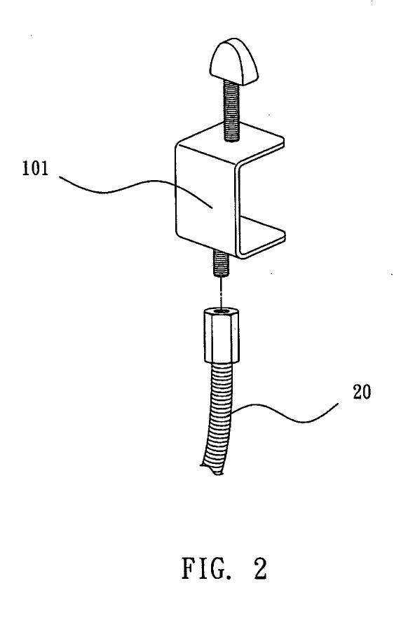

Refer to FIG. 2 for an illustration of the connection between the fixing member 101 and the flexible tube-shaped video camera 20 of the present invention. In this invention, an easily mountable fixing member 101 may be used to freely mount the flexible tube-shaped video camera 20 onto any part of the surgical light set 10, such as the surgical light 15, the fixed base 11, or the rotary arm set 13. As shown in FIG. 2, the flexible tube-shaped video camera 20 may be but is not limited to being connected to the fixing member 101 via a screw. Since the methods of connecting various mechanical components are well known in the art, further elaboration is omitted.

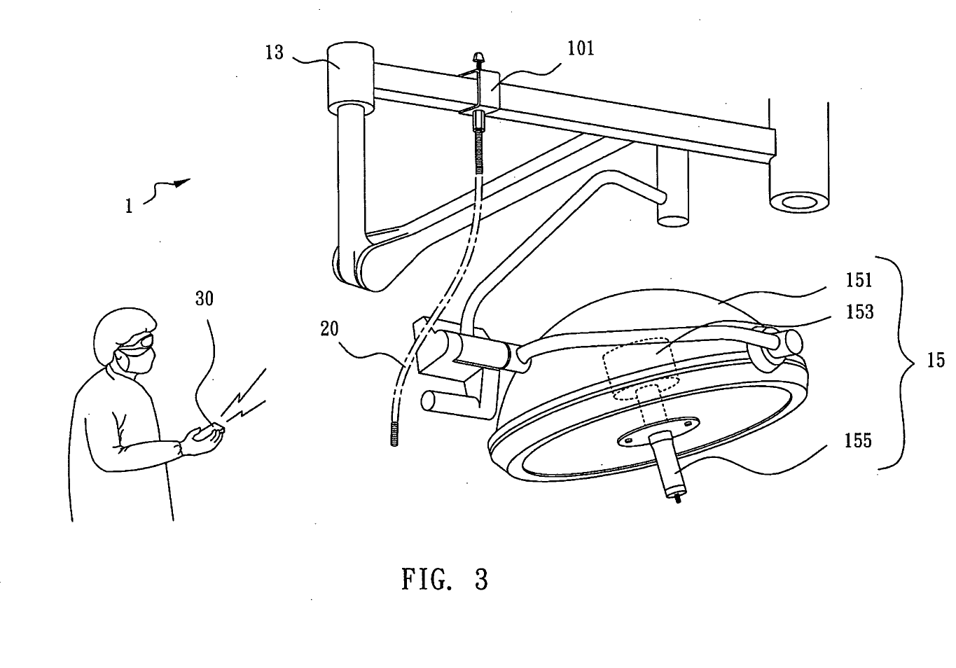

Refer to FIG. 3 for an illustration of another embodiment of the surgical lighting system 1 with an image-recording function of this invention. In this embodiment, the flexible tube-shaped video camera 20 is detachably mounted to the rotary arm set 13 by the fixing member 101. Thus, users may decide whether or not to install the flexible tube-shaped video camera 20 as needed.

In most situations, the flexible tube-shaped video camera 20 has a built-in memory so that it may store a video recording of a specific duration. However, a transmission wire may also be used to transmit the captured images to an external device, such as a computer or other storage medium.

Furthermore, the surgical light 15 may comprise a light cover 151 defining a lighting space; a light source 153 installed in the lighting space; and a handle 155 allowing a user to control the orientation of the light cover 151.

In most cases, the flexible tube-shaped video camera 20 is without any limitation detachably connected to the handle 155. In addition, in some cases where the handle 155 is encased in a protective cover, the flexible tube-shaped video camera 20 may still connected to the handle 155, either by passing through the protective cover or by being mounted on the protective cover. In most situations, the shape of the handle 155 is not specifically limited.

Preferably, the flexible tube-shaped video camera 20 may have a zoom function and focus controls; thus, it may actively vary its focus in accordance with its position or passively be controlled manually. In addition, the surgical lighting system 1 with an image-recording function of this invention may further comprise a remote control 30 for controlling the flexible tube-shaped video camera 20. In that case, depending on the quality of the image captured by the flexible tube-shaped video camera 20, users may determine whether or not to change the zoom and focus to obtain a clearer image.

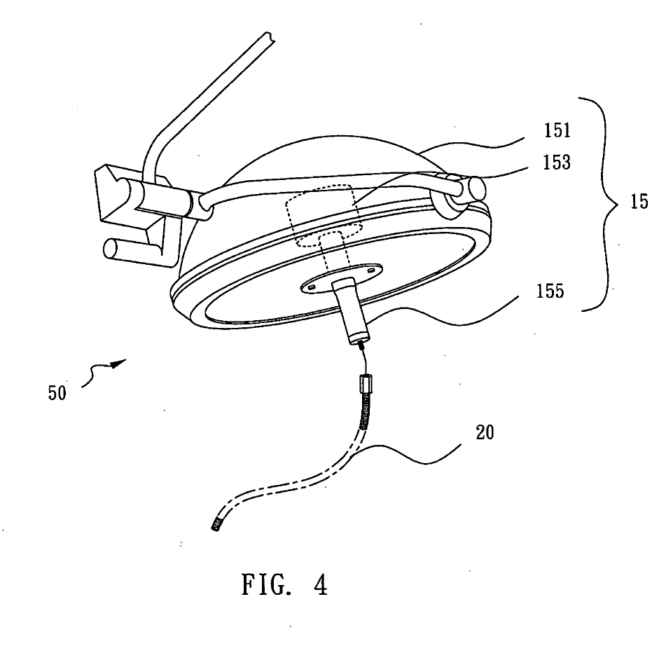

Please refer to FIG. 4 for an illustration of one embodiment of the surgical light with an image-recording function 50 of this invention. As shown, the surgical light with an image-recording function 50 of this invention mainly comprises a surgical light 15 and a flexible tube-shaped video camera 20 connected thereto. The surgical light 15 mainly comprises: (a) a light cover 151 defining a lighting space; (b) a light source 153 installed in the lighting space; and (c) a handle 155 allowing a user to control the orientation of the light cover 151.

In most situations, the flexible tube-shaped video camera 20, without any limitation, is connected to the handle 155.

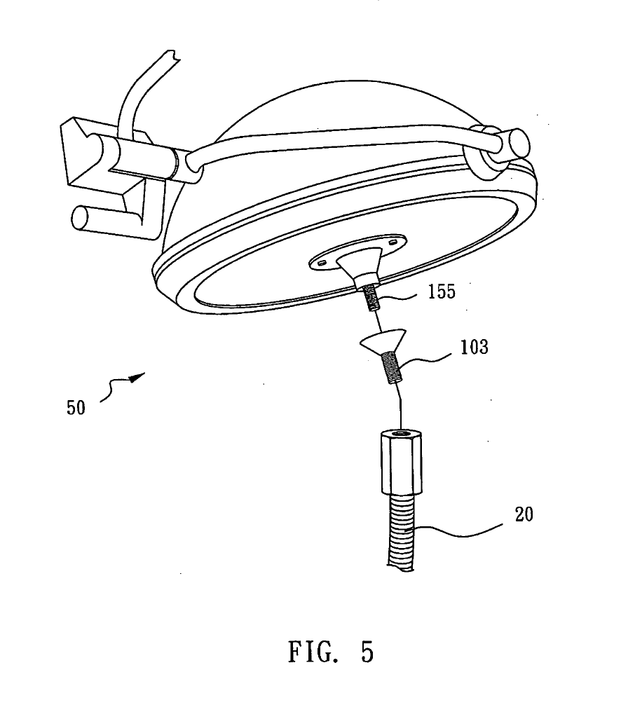

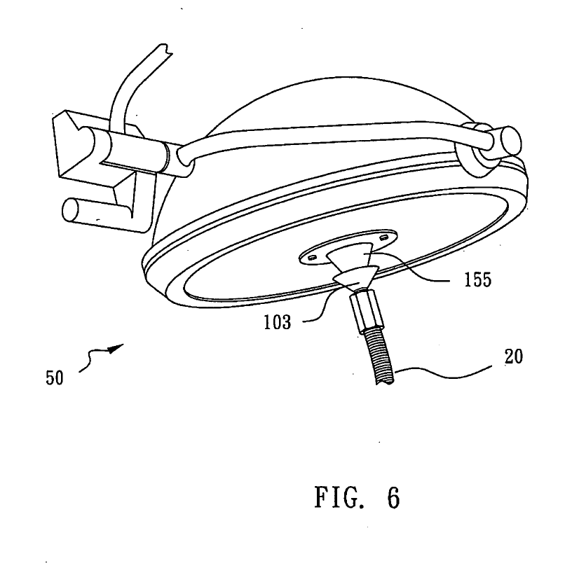

Refer to FIGS. 5 and 6 for illustrations of another embodiment of the surgical light with an image-recording function 50 of this invention. In some situations, when the surgical light with an image-recording function 50 is to be used, a protective cover 103 may be put on the handle 155 in advance so as to prevent contamination. Accordingly, users may move the handle 155 by holding onto the protective cover 103 wrapped thereon during the surgical operation. Therefore, the handle 155 is kept intact, and the protective cover 103 may be disposed of or pasteurized after the surgical operation. In the aforementioned case, the flexible tube-shaped video camera 20 may be screwed to the protective cover 103 and indirectly connected to the handle 155. Obviously, aside from a screw-type connection, other connection means may provide the same effect, and the connection may be detachable or not.

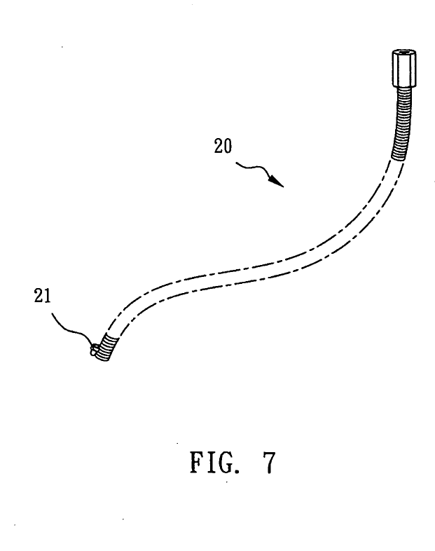

Finally, refer to FIG. 7 for an illustration of one embodiment of the flexible tube-shaped video camera 20 of this invention. As shown, the flexible tube-shaped video camera 20 may selectively comprise an indicator 21 capable of projecting a visible light beam onto an opaque surface and forming a light spot thereon. Thus, users may confirm the image-recording field of the flexible tube-shaped video camera 20 and have a general idea of the current image-recording scope of the flexible tube-shaped video camera 20.

It will be understood that many other modifications can be made to the various disclosed embodiments without departing from the spirit and scope of the invention. For these reasons, the above description should not be construed as limiting the invention, but should be interpreted as merely exemplary of preferred embodiments.

What is claimed is:

1. Surgical lighting system with an image-recording function, comprising:
a surgical light set, comprising:
(a) a fixed base;
(b) a rotary arm set pivoted to the fixed base, the rotary arm set comprising at least one rotary arm; and
(c) a surgical light connected to one rotary arm of the rotary arm set; and
a flexible tube-shaped video camera connected to the surgical light set.

2. The surgical lighting system as claimed in claim 1, wherein the flexible tube-shaped video camera is detachably connected to the surgical light set.

3. The surgical lighting system as claimed in claim 1, wherein the flexible tube-shaped video camera is connected to the surgical light.

4. The surgical lighting system as claimed in claim 1, wherein the surgical light comprises:
a light cover defining a lighting space;
a light source installed in the lighting space; and
a handle allowing a user to control the orientation of the light cover, wherein the flexible tube-shaped video camera is connected to the handle.

5. The surgical lighting system as claimed in claim 1, wherein the flexible tube-shaped video camera is detachably connected to the surgical light.

6. The surgical lighting system as claimed in claim 1, wherein the flexible tube-shaped video camera is connected to the rotary arm set.

7. The surgical lighting system as claimed in claim 1, wherein the flexible tube-shaped video camera is connected to the fixed base.

8. The surgical lighting system as claimed in claim 1, wherein the flexible tube-shaped video camera is zoomable.

9. The surgical lighting system as claimed in claim 8, further comprising a remote control for controlling the flexible tube-shaped video camera.

10. The surgical lighting system as claimed in claim 1, wherein the flexible tube-shaped video camera comprises an indicator.

11. A surgical light with an image-recording function which may enable a user to make a video recording of a surgical procedure, the surgical light with an image-recording function comprising:
a surgical light, comprising:
(a) a light cover defining a lighting space;
(b) a light source installed in the lighting space; and
(c) a handle allowing a user to control the orientation of the light cover; and
a flexible tube-shaped video camera connected to the surgical light.

12. The surgical light with an image-recording function as claimed in claim 11, wherein the flexible tube-shaped video camera is detachably connected to the surgical light.

13. The surgical light with an image-recording function as claimed in claim 11, wherein the flexible tube-shaped video camera is connected to the handle.

14. The surgical light with an image-recording function as claimed in claim 11, wherein the flexible tube-shaped video camera is zoomable.

15. The surgical light with an image-recording function as claimed in claim 11, wherein the flexible tube-shaped video camera may be controlled by a remote control.

16. The surgical light with an image-recording function as claimed in claim 11, wherein the flexible tube-shaped video camera comprises an indicator.
